(19) United States
(12) Patent Application Publication
(10) Pub. No.: US 2020/0124022 A1
(43) Pub. Date: Apr. 23, 2020

(54) MOBILE CONTROL UNIT FOR A WIND TURBINE

(71) Applicant: Wobben Properties GmbH, Aurich (DE)

(72) Inventors: Steffen JANSSEN, Aurich (DE); Daniel REITER, Aurich (DE)

(21) Appl. No.: 16/626,218

(22) PCT Filed: Jun. 29, 2018
(86) PCT No.: PCT/EP2018/067671

§ 371 Date: Dec. 23, 2019

(30) Foreign Application Priority Data
Jul. 4, 2017 (DE) 10 2017 114 915.5

(51) Int. Cl. F03D 7/02; F03D 7/04

(52) U.S. Cl. CPC F03D 7/0224; F03D 17/00; F03D 7/048; F03D 7/047

(57) ABSTRACT

There is provided a mobile control unit for a wind turbine which has a plurality of components. The mobile control unit has a supply module having a main control unit and at least one control module coupled to the supply module for controlling the components of the wind turbine. The main control unit serves for controlling the components of the wind turbine by means of the control modules connected to the supply module.

### BACKGROUND

### Technical Field

The present invention concerns a mobile control unit for a wind turbine, a use of a mobile control unit and a method of controlling a wind turbine.

### Description of the Related Art

When a wind turbine is set up the wind turbine is connected to the supply grid so that the wind turbine can take energy from the supply grid in order for example to provide for adjustment of the pitch angles of the rotor blades or the yaw angle. As long as the wind turbine is not yet connected to the supply grid however the wind turbine cannot be correspondingly controlled because the corresponding power supply is not present. In order nonetheless to control the wind turbine a mobile supply module can be used when assembling the wind turbine.

On the German patent application from which priority is claimed the German Patent and Trade Mark Office searched the following documents: U.S. Pat. Nos. 9,353,730 B2, 8,882,441 B2, US 2011/0 260 533 A1, US 2015/0 115 609 A1 and WO 2015/188 830 A1.

### BRIEF SUMMARY

Provided is a mobile control unit for a wind turbine, which is simple to operate and which can be used in versatile fashion.

Provided is a use of a mobile control unit for a wind turbine while the wind turbine is not connected to a power supply grid or during maintenance of the wind turbine. The mobile control unit has a supply module having a main control unit and at least one control module for controlling a component of the wind turbine. The at least one control module is coupled to the supply module and is supplied with voltage and control commands by the supply module.

The mobile control unit is used in particular when the wind turbine is not in normal operation and can generate power and cannot take power from the power supply grid (for example upon installation, dismantling or in a maintenance operation).

According to an aspect of the present invention the mobile control unit has an operating unit for controlling the at least one control module for controlling a component of the wind turbine. In that way a service team member can operate the respective components of the wind turbine like for example the pitch motors, the yaw motors or the rotor brake, even if the wind turbine is not connected to a power supply grid (or if the wind turbine is not supplied with power by the power supply grid or if maintenance of the wind turbine is being performed).

According to a further aspect of the invention provided between the supply module and the at least one control module is a connecting line, by means of which the voltage for the control modules and the control commands can be transmitted.

Provided is a method of controlling a wind turbine which is not connected to the power supply grid. A mobile control unit is positioned in a pod of the wind turbine. At least one control module is connected to the supply module and to a component of the wind turbine that is to be controlled. The components of the wind turbine are controlled by means of an operating portion of the supply module. The mobile control unit is removed when the wind turbine is connected to the power supply grid or when the maintenance operation is concluded.

According to an aspect of the present invention the mobile control unit for a wind turbine has a supply module, an operating portion, a connection for a power supply and at least one control module for controlling a component of the wind turbine. The control module can represent for example a pitch module for controlling the pitch angles of the rotor blades, a yaw module for controlling the yaw angle or a brake module. The supply module is used in particular upon installation, maintenance and dismantling of the wind turbine, that is to say when the wind turbine is not connected to the power supply grid or coupled thereto. The supply module can serve as a voltage supply and a main control unit.

According to an aspect of the present invention the supply module can have a control cabinet and a frame so that the supply module can be hoisted into the pod of the wind turbine for example by means of a winch. In the pod the required modules can then be connected to the supply module in order to control the pitch motor, the yaw motor and/or the rotor brake.

Optionally tires or rollers can be mounted to the frame of the supply module to improve the mobility of the module.

A CEE-16 A power socket can be provided at the power module. There can also be provided connections for the connecting lines of the respective modules.

According to an aspect of the present invention there can be provided a radio remote control to be able to control the supply module. The supply module can have a radio receiver for that purpose. Control of the pitch angles of the rotor blades, control of the yaw angle and/or control of the rotor brake can be implemented by means of the remote control or by means of the emergency operating unit.

Provided is a mobile control unit for a wind turbine which has a plurality of components. The mobile control unit has a supply module having a main control unit and at least one control module coupled to the supply module for controlling the components of the wind turbine. The main control unit serves to control the components of the wind turbine by means of the control modules connected to the supply module.

After the wind turbine has been connected to the power supply grid the mobile control unit can be removed with the supply module and the control modules.

Further configurations of the invention are subject-matter of the appendant claims.

### BRIEF DESCRIPTION OF THE SEVERAL VIEWS OF THE DRAWINGS

Advantages and embodiments by way of example of the invention are described more fully hereinafter with reference to the drawing.

FIG. 1 shows a diagrammatic view of a wind turbine according to the invention, and

FIG. 2 shows a diagrammatic view of a mobile control unit and parts of a wind turbine.

### DETAILED DESCRIPTION

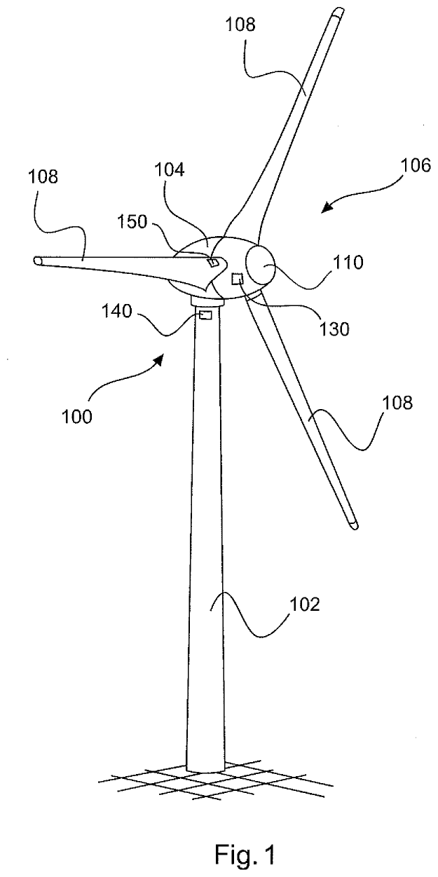

FIG. 1 shows a diagrammatic view of a wind turbine according to the invention. The wind turbine 100 has a tower 102 and a pod 104 on the tower 102. Provided at the pod 104 is an aerodynamic rotor 106 with three rotor blades 108 and a spinner 110. In operation of the wind turbine the aerodynamic rotor 106 is set in rotation by the wind and thus also rotates a rotor or rotor member of a generator directly or indirectly coupled to the aerodynamic rotor 106. The electric generator is arranged in the pod 104 and generates electric power. The pitch angles of the rotor blades 108 can be altered by pitch motors 150 at the rotor blade roots 108b of the respective rotor blades 108.

The pitch angle of the rotor blades 108 can be adjusted by means of pitch motors 150. The yaw angle of the rotor 106 or the pod 104 of the wind turbine can be adjusted by means of yaw motors 140. In addition the wind turbine can have a rotor brake 130 which serves to arrest the rotor.

The wind turbine typically has a decentral control, that is to say the respective components of the wind turbine like the pitch motors for adjusting the rotor blades, the yaw motors for adjusting the yaw angle and the like are controlled decentrally by the respective control modules. As an alternative thereto a central control system is also possible.

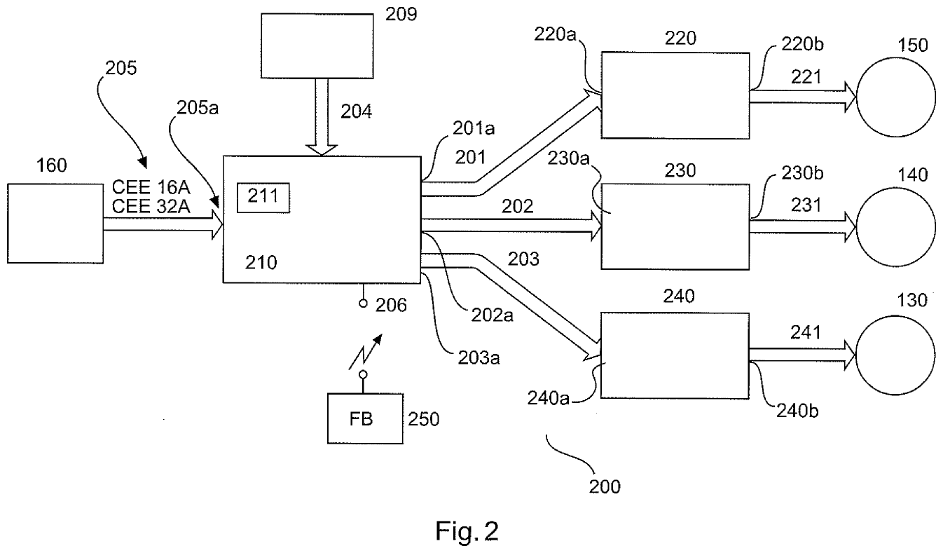

FIG. 2 shows a diagrammatic view of a mobile control unit and parts of a wind turbine. The mobile control unit 200 has a supply module 210 and at least one further control module like for example a pitch module 220, a yaw module 230 and/or a rotor brake module 240, i.e converters. The mobile control unit can further have an operating unit 209 and optionally a remote control 250.

The supply module 210 has connections 201a-203a for connecting lines 201-203 for the pitch module 220, the yaw module 230 and/or the rotor brake module 240. The pitch module 220 has a connection 220a for the connecting line 201 and a connection 220b for a pitch cable 221, by means of which the pitch module 220 can be coupled to at least one of the pitch motors 150. The yaw module 230 has a first connection 230a for a connecting line 202 and a second connection 230b for a yaw cable 231, by means of which the yaw module 230 can be coupled to the yaw motors 140. The rotor brake module 240 has a first connection 240a for a connecting line 203 and a second connection 240b for a brake cable 241, with which the rotor brake module 240 can be coupled to the rotor brake 130.

The supply module 210 has an input connection 205a to which a supply line 205 can be connected. In this arrangement a power supply 160 can be connected by way of the supply line 205 to the connection 205a of the supply module 210 and thus supply the supply module 210 with power. Optionally there can be an emergency operating unit 209 which can be coupled to the supply module by way of a connecting line 204. The supply module can optionally have a receiving unit 206 for receiving the commands of the remote control 250.

Optionally the supply module 210 can have a frame and wheels or rollers. The supply module can be conveyed for example by means of a winch into the pod of the wind turbine. The mobile control unit is used in particular when the wind turbine is not connected to the power supply grid or electrically coupled thereto and thus cannot draw energy from the power supply grid. That is the situation for example upon installation, overhaul, maintenance or dismantling of the wind turbine. The mobile control unit is therefore used only when the wind turbine is not connected to the power supply grid. As soon as the wind turbine is connected to the power supply grid the mobile control unit can be removed from the pod again.

The pitch module 220 serves to control the pitch angle of the rotor blades 108 of the wind turbine. For that purpose the pitch module 220 can control in particular the blade connection mounting. The pitch module 220 can have for example a control cabinet having a connection 220a for the connecting line 201 which is connected to the supply module 220, and a connection 220b to which the pitch cable 221 for the pitch motors 150 is connected. The pitch module 220 serves to convert the voltage from the supply module 210 into the voltage required for the pitch motors 150.

Control of the pitch motors 150 by means of the pitch module 220 can thus be effected for example by means of the remote control 250 or alternatively by means of the emergency operating unit 209. Accordingly there is no control or operation of the pitch module 220 and rather operation is effected by way of the supply module 210.

The yaw module 230 has a first connection 230a for connection by way of the connecting line 220 to the supply module 210 and a further connection 230b for connection of the yaw cable 231. The yaw module 230 distributes the voltage from the supply module 210 for example by way of fuses to the motors and the brakes thereof.

The rotor brake module 240 has a first connection 240a for connecting the connecting line 203 and a second connection 240b for connecting the brake cable 241. In the rotor brake module 240 the voltage from the supply module is switched by components to units of the brake so that the latter performs the function then required (release or stop).

As in the case of the pitch module 220 there is no direct control of the yaw module 230 or the rotor brake module 240 by the operator. Rather, control is effected by the supply module 210 for example by means of the remote control 250 or the emergency operating unit 209.

The supply module 210 represents a main control unit of the mobile control unit 200. The control modules 220-240 connected to the supply module 210 are controlled by means of the remote control 250 or alternatively thereto by means of the emergency operating unit 209.

According to an aspect of the present invention the mobile control unit is used when for example control cabinets or control units of the wind turbine (which are designed for normal use) are not yet connected or if they are defective and a maintenance procedure is to be performed.

A mobile and modular control unit is provided with the mobile control unit. Depending on the respective requirement the control modules needed (pitch module, yaw module, rotor brake module) can be connected to the supply module.

According to an aspect of the present invention the control modules 220-240 connected to the supply module 210 are automatically detected. This therefore provides a plug-and-play system.

The control modules and therewith the motors connected thereto are controlled by way of the supply module or the remote control or the emergency operating unit 209. Control of the control modules at the control modules themselves is no longer possible. Control of the supply module 210 can be updated or changed by way of an optional universal serial bus (USB) connection or by way of an optional wireless receiving unit.

The number of control modules which are required to control a plurality of wind turbines can be considerably reduced by the mobile modular control unit.

The mobile control unit represents an operating means for construction, maintenance and dismantling of wind turbines. For example pitch motors or yaw motors can be operated and/or a rotor brake can be released or applied by means of the mobile control unit. The mobile control unit represents a modular system which can be used for a large number of wind turbines if the wind turbine is not connected to the supply grid.

According to an aspect of the present invention the supply module of the mobile control unit can have a safety technology unit for example for emergency disconnection-switch-off. The supply module can also be used as a current distributor to supply the control modules with power.

According to an aspect of the present invention it is possible to store in each of the control modules a parameter set, by means of which control of the pitch motors, the yaw motors or the rotor brake can be effected. Those parameters can vary for different wind turbines.

The mobile control unit can be controlled by means of the radio remote control. That is advantageous because in that way it is possible for example to remotely control the pitch motors, the yaw motors or the rotor brake. The mobile control unit can be used by updating the parameter sets in the control modules for different wind turbines, that is to say the mobile control unit can be used universally. Optionally the supply module can automatically detect control units which are freshly employed or connected to the supply module. The mobile control unit is advantageous because it is no longer necessary therewith to carry around so many different control modules. Furthermore fewer spare parts have to be stocked.

According to an aspect of the present invention the pitch motors 150 can be in the form of DC motors. The pitch module 220 then serves to control the DC pitch motor. In particular control of the DC motors is to be effected in such a way that the maximum torque of the motor can be maintained even in a warm state of the motor.

The pitch module 220 can provide a voltage for the field winding and for the armature winding of the DC motor. Those voltages are DC voltages of between 10 and 500 volts. Furthermore the pitch module 220 can provide a brake voltage in the form of a DC voltage (10 to 550 volts) for the DC motor.

The DC motors 250 can optionally output a temperature signal and a rotary speed signal to the pitch module 220. For that purpose the DC motors can have a temperature sensor and a rotary encoder. The pitch module 220 provides a field voltage for the field winding of the DC motor and supplies the field voltage at a constant current, that is to say the field voltage is so regulated that a constant current can be provided in the field winding. If however the temperature of the winding of the DC motor rises that also leads to an increase in the electrical resistance of the winding. A higher electrical resistance in turn results in a lesser flow of current and thus a weakening of the magnetic field of the field winding. That in turn has the result that the torque of the motor falls. The pitch module 220 can have supplied a target value for the current in the field winding and can suitably regulate the field voltage so that the field winding has an optimum magnetic field strength.

The armature voltage at the armature winding can also be detected by the pitch module 220. The pitch module 220 can control the rotary speed of the DC motors by the armature voltage being reduced or increased. Furthermore the direction of rotation of the motor can be adapted by the pitch module 220. The pitch module 220 can detect the voltage in the field winding and in the armature winding as well as the currents flowing in that case and prepare them for display. The brake voltage, the field voltage and the armature voltage can be monitored and regulated. For example upon an interruption in power the voltage supply can be reduced or switched off. In addition thereto the motor brake can be activated. By virtue of the fact that the field voltage and the armature voltage are monitored by the pitch module 220 it is possible to detect a defect in the DC motor.

The pitch module 220 provides a limit voltage for the brake of the DC motor, which can be open-loop or closed-loop controlled independently of the field voltage and the armature voltage. The brake can be activated in the case of a line interruption. The pitch module 220 can have for example seven separately actuable insulated-gate bipolar transistors (IGBTs) in order to be able to separately regulate the field voltage, the brake voltage and the armature voltage.

By suitable control of the motors 150 it is possible to reverse the direction of rotation of the motor.

Overloading or overheating of the motor can be prevented by optional detection of the motor temperature.

An excessive speed of rotation can be avoided by optional detection of the speed of rotation of the motor.

A rotary speed-dependent control of the DC pitch motors 150 can be achieved with the pitch module 200. In particular the DC motors can be controlled in such a way that a constant current flows in the field winding.

1. A method comprising:
using a mobile control unit, controlling one or more components of a wind turbine while the wind turbine is not connected to a power supply grid or during maintenance of the wind turbine such that the wind turbine cannot take power from the power supply grid,
wherein the mobile control unit includes:
a supply module having a main control unit, and
one or more control modules for controlling the one or more components, respectively, wherein the one or more control modules are coupled to the supply module and configured to receive signals and a voltage from the supply module,
wherein the one or more control modules are directly coupled to a respective one of the one or more components of the wind turbine, and
wherein the one or more components of the wind turbine include one or more of: a pitch motor, a yaw motor, or a rotor brake.

2. The method according to claim 1 wherein the mobile control unit has an operating unit for controlling the one or more control modules.

3. (canceled)

4. The method according to claim 1 further comprising one or more connecting lines between the supply module and the one or more control modules, respectively, the method further comprising transmitting the voltage for the control modules and the control commands on the one or more connecting lines.

5. A method comprising:
controlling a wind turbine that is not connected to a power supply grid or during maintenance of the wind turbine such that the wind turbine cannot take power from the power supply grid for controlling the one or more components of the wind turbine, the controlling comprising:
positioning a mobile control unit having at least one mobile control module in a pod of the wind turbine,
positioning and connecting the at least one mobile control module to the supply module and directly to the one or more components of the wind turbine,
wherein the one or more components of the wind turbine are one or more of: a pitch motor, a yaw motor, or a rotor brake, and
controlling the one or more components of the wind turbine by an operating portion, and
removing the mobile control unit and at least one mobile control module after the wind turbine is connected to the power supply grid or the maintenance operation is concluded.

6. A mobile control unit for a wind turbine which has a plurality of components, the mobile control unit comprising:
a supply module having a main control unit; and
a control module coupled to the supply module by a connection line, wherein the control module is configured to control one of the plurality of components of the wind turbine,
wherein the control module is directly coupled to the one of the plurality of components of the wind turbine, and
wherein the main control unit is configured to control the one of the plurality of components of the wind turbine using the control module.

7. The mobile control unit according to claim 6 comprising a plurality of control modules, each of the plurality of control modules being coupled to the supply module and a respective one of the plurality of components, wherein the main control unit is configured to control the plurality of components, respectively, using the plurality of control modules.

8. The mobile control unit according to claim 6 further comprising an operating unit for controlling the control module.

9. The mobile control unity according to claim 6 wherein the plurality of components of the wind turbine include a pitch motor, a yaw motor, or a rotor brake.

10. The mobile control unit according to claim 6 further comprising a remote controller configured to send signals to the supply module.
